(19) United States
(12) Patent Application Publication
(10) Pub. No.: US 2008/0053010 A1
(43) Pub. Date: Mar. 6, 2008

(54) LOCKABLE SHUTTER ASSEMBLY

(76) Inventors: Clyde Allen, Lapeer, MI (US); Brad Kutler, Lake Orion, MI (US); Nathan Greenway, Metamora, MI (US); Richard J. Logan, Oxford, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/470,501

(22) Filed: Sep. 6, 2006

(51) Int. Cl. E06B 3/26

(52) U.S. Cl. 52/202

(57) ABSTRACT

A lockable shutter assembly has first and second shutters mounted operatively to a building and movable between open and closed positions. A locking device of the assembly has a bracket that extends longitudinally along a gap formed between the shutters when in the closed position. The bracket is supported slidably by the first shutter via a sliding coupling and regardless of shutter position. A releasable interlock of the locking device is carried between the bracket and the second shutter and generally operates between released and locked states. The assembly is placed into the locked state by movement of the bracket when the shutters are in the closed position.

### FIELD OF THE INVENTION

The subject invention generally relates to a shutter assembly and more particularly to a reinforced, locking, shutter assembly that withstands inclement weather.

### BACKGROUND OF THE INVENTION

Various locking assemblies for shutters are known in the art. It is generally known that locking assemblies are utilized, when necessary, to lock pairs of shutters in a closed position on a dwelling. Shutters are used for both aesthetic and functional purposes on the dwelling. In the closed position, the shutters function to protect windows, doors, and other openings of the dwelling during inclement weather, such as precipitation storms, wind storms, and hurricanes.

During such inclement weather, it is pertinent to lock, or retain, the shutters in the closed position such that the shutters can continue to provide adequate protection to the windows, doors, and other openings during and throughout the inclement weather. If the weather causes the shutters to open then the functional purpose of the shutters is defeated.

Conventional assemblies for locking pairs of shutters in the closed position are deficient for many reasons. For instance, the locking assemblies of the prior art do not adequately retain the shutters in the closed position throughout the inclement weather. In these assemblies, wind either bends or breaks the assembly causing the shutters to open. Also, many conventional locking assemblies require excessive modification and direct drilling into and through the shutters to adequately retain the shutters in the closed position. In these assemblies the fastener extends through at least a portion of the shutters. As a result and to a varying degree, these conventional locking assemblies damage the shutters such that, after the inclement weather, the aesthetic purpose of the shutters is negatively impacted.

Furthermore, some conventional locking assemblies, also referred to in the art as storm or locking bars, create an emergency egress issue that prevents occupants of the dwelling from escaping during an emergency, such as a fire. More specifically, a conventional storm bar is mounted across the shutters once the shutters have been closed. The storm bar is secured, typically screwed, into the dwelling on each side of the closed shutters to prevent the shutters from opening during the inclement weather. Screws are also used to connect the shutters to the storm bar such that the shutters can not be blown, or otherwise deflected, inward, i.e., toward the dwelling, during the inclement weather. With the storm bar screwed to the dwelling and the shutter screwed to the storm bar, the occupants of the dwelling cannot open a window or door from within the dwelling to release the storm bar and escape.

Due to the deficiencies in the locking assemblies of the prior art, including those described above, it is desirable to provide a novel locking assembly for shutters that adequately retains the shutters in a closed position on a dwelling such that protection to a window, door, or other opening is maximized throughout any inclement weather. It is also desirable to provide a locking assembly for shutters that can easily be unlocked and opened from either side and when unlocked is clear of the opening.

### SUMMARY OF THE INVENTION AND ADVANTAGES

A lockable shutter assembly has first and second shutters mounted operatively to a building and movable between open and closed positions. A locking device of the assembly has a bracket that extends longitudinally along a gap formed between the shutters when in the closed position. The bracket is supported slidably by the first shutter via a sliding coupling and regardless of shutter position. A releasable interlock of the locking device is carried between the bracket and the second shutter and generally operates between released and locked states. The assembly is placed into the locked state by movement of the bracket when the shutters are in the closed position.

Preferably, the bracket of the locking device is I-Shaped having a web disposed laterally between and perpendicular to inner and outer flanges and in the gap when the assembly is closed. Each flange has a first fin projecting laterally away from the web. The first fins carry in-part the sliding coupling and engage both exterior and interior surfaces or sides of the first shutter. Second fins of each flange project in an opposite direction from the first fins and are located directly adjacent to the respective exterior and interior surfaces or sides of the second shutter when the assembly is in the closed position for adding strength and rigidity of the closed assembly during inclement weather. The releasable interlock is preferably carried between the web and a distal edge face of the second shutter.

Objects features and advantages of the present invention include a shutter assembly that can be unlocked and opened, and closed and locked from either the interior or exterior of a building. Other advantages include a locking device that is fully supported by the shutters and adds strength and rigidity to the shutters when in the closed position to resist inclement weather. Yet further, the assembly is relatively attractive when in the open position, relatively simple and robust in design, inexpensive to manufacture and in service has a long and useful life.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a shutter assembly embodying the present invention and having a pair of shutters illustrated in a closed position and a locking device illustrated in a locked state;

FIG. 2 is a perspective view of the right shutter of the assembly;

FIG. 3 is a distal edge view of the right shutter;

FIG. 4 is a perspective view of the left shutter with an elongated member of the locking device illustrated in a released state;

FIG. 5 is a distal edge view of the left shutter;

FIG. 6 is a partial top view of the shutter assembly;

FIG. 7 is a partial perspective view of the locking device of the assembly taken from circle 7 of FIG. 4;

FIG. 8 is a partial perspective view of the locking device similar to FIG. 7 except illustrating a released state of the locking device;

FIG. 9 is a partial perspective view of the locking device taken from circle 9 of FIG. 2; and

FIG. 10 is an enlarged and partial distal edge view of the right shutter illustrating a mortise of the locking device and taken from circle 10 of FIG. 5.

### DETAILED DESCRIPTION OF THE PREFERRED EMBODIMENT

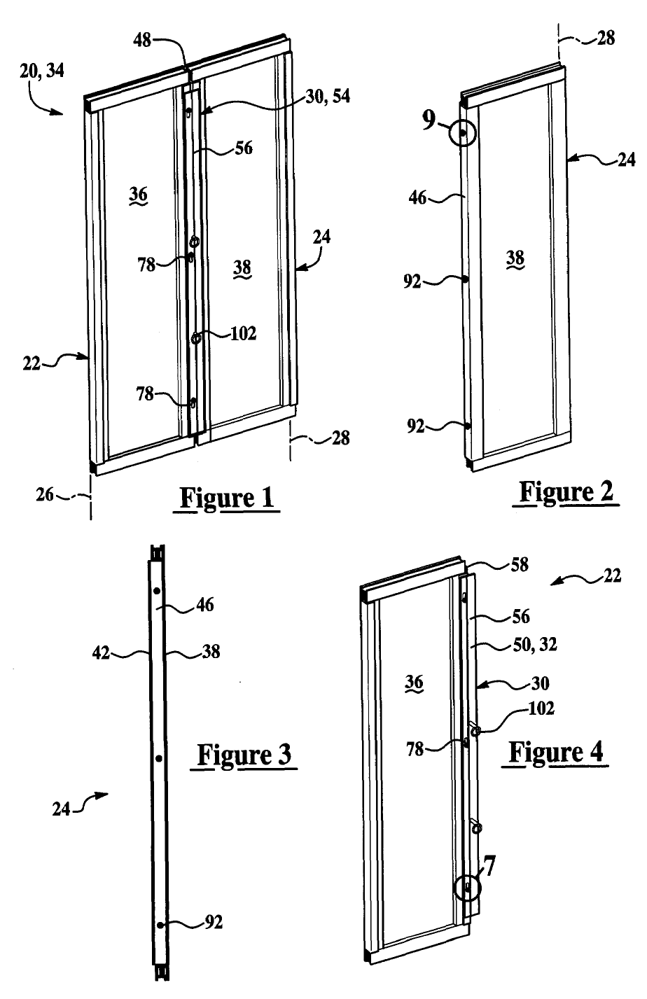

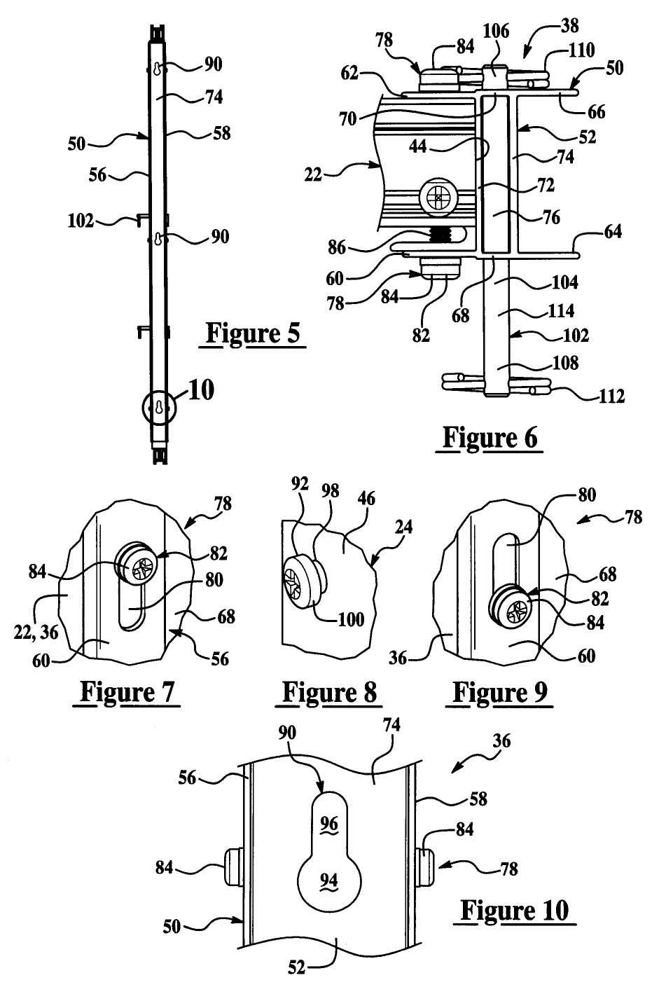

Referring to the Figures, wherein like numerals indicate like or corresponding parts throughout the several views, a locking shutter assembly 20 of the present invention has a pair of shutters 22, 24 that mount slidably to the exterior of a structure such as an industrial building or dwelling (not shown). Preferably, the first or left shutter 22 has a substantially horizontal direction of movement as illustrated by arrow 25 in FIG. 1 and the second or right shutter 24 has a substantially horizontal direction of movement as illustrated by arrow 27 in FIG. 1. Preferably the shutters 22, 24 slide open and closed similar to that of a traditional sliding French door arrangement and/or similar to that disclosed in U.S. patent application Ser. No. 11/428,739, titled: “Shutter Assembly,” filed Jul. 5, 2006, assigned to the same assignee as the present invention, and incorporated herein by reference in its entirety.

When the shutters 22, 24 are in an open position during mild weather conditions, they preferably lay flat to the structure so as not to obstruct the opening. When in a closed position 34, the shutter assembly 20 protects the windows and/or doors from inclement weather, such as precipitation storms, wind storms, and hurricanes. To accomplish this protection, the shutter assembly 20 has a locking device 30 that reinforces and locks closed the shutters 22, 24 of the assembly 20.

The shutters 22, 24 preferably slide in opposite directions to one-another and along respective arrows 25, 27 when closing to cover the opening during inclement weather. The locking device 30 of the assembly 20 is generally integrated directly into both the left and right shutters 22, 24 and preferably is free of the building so that when the shutters are in the open position, and thus the device is in a released state 32, the opening in the building is not obstructed by any portion of the assembly 20 including the device 30. With respect to the building and when the left and right shutters 22, 24 are in the closed position 34, each shutter has and carries a respective first or inside surface 36, 38 and a respective second or outside surface 40, 42. The thickness of the shutters 22, 24 is generally equal to the width of distal edge faces 44, 46 carried by the respective shutters and that face one another and define an elongated and substantially vertical gap 48 between one-another. Preferably, the distal edge faces 44, 46 are substantially parallel to one-another and perpendicularly to movement directions 25, 27. The locking device 30 preferably has an elongated retention bracket 50 that preferably has a lateral cross-section generally forming an I-Shape. The bracket 50 is supported slidably and carried by the left shutter 22 regardless of whether the assembly 20 is in the open position or the closed position 34. The bracket 50 has a longitudinally extending web 52 disposed in the gap 48 when the shutters 22, 24 are in the closed position 34 and regardless of the device 30 being in a locked state 54 or the released state 32. Preferably, the bracket 50 has an elongated inner flange or plate 56 and an elongated outer flange or plate 58 spaced from one-another by the lateral width of the elongated web 52 and co-extending longitudinally with the web 52. Each flange 56, 58 has respective left fins 60, 62 and respective right fins 64, 66 projecting laterally outward in opposite directions and from respective mid or connecting portions 68, 70 of the inner and outer flanges 56, 58 respectively.

Preferably, the web 52 of the bracket 50 is hollow, thus the web 52 has a first wall 72 generally facing the edge face 44 of the left shutter 22 regardless of the position of the assembly 20, and a second wall 74 that faces and is orientated adjacent to the distal edge face of the right shutter 46 but only when the assembly 20 is generally in the closed position 34. A substantially vertical channel 76 in the web 52 is defined by the first and second walls 72, 74 and the mid portions 68, 70 of the respective flanges 56, 58. The left fin 60 of the inner flange 56 is located adjacent and slidably to the inside surface 36 of the left shutter 22 regardless of assembly 20 position. The left fin 62 of the outer flange 58 is located adjacent and slidably to the outside surface 40 of the left shutter 22 regardless of assembly 20 position. The first wall 72 of the web 52 is located adjacent and slidably to the distal edge face 44 of the left shutter 22 regardless of assembly 20 position. The right fin 64 of the inner flange 56 is located adjacent and slidably to the inside surface 38 of the right shutter 24 only generally when the assembly 20 is in the closed position 34. The right fin 66 of the outer flange 58 is located adjacent and slidably to the outside surface 42 of the right shutter 24 only generally when the assembly 20 is in the closed position 34. The second wall 74 of the web 52 is located adjacent and slidably to the distal edge face 46 of the right shutter 24 only generally when the assembly 20 is in the closed position 34.

The bracket 50 is engaged slidably to the left shutter by a sliding coupler 78 of the locking device 30 carried between the inside and outside surfaces 36, 40 of the left shutter 22 and the associated left fins 60, 62 of the bracket 50. Preferably, the coupler 78 has a series of slightly elongated and vertical slots 80 spaced vertically above one another and located in both left fins 60, 62 of the respective inner and outer flanges 56, 58. Associated with each slot 80 is a respective pin 82 projecting rigidly outward from the inside and outside surfaces 36, 40 of the left shutter 22. Each pin 82 has a enlarged head 84 having a diameter that is larger than the width of the slot 80, and a cylindrical shank 86 extending axially between the left shutter 22 and the enlarged head 84 and through each respective slot 80. Preferably, the shanks 86 are threaded for rigid engagement to the left shutter 22. Preferably, when the pins 82 are located in an upper end of the respective slots 80 the locking device 30 is in the locked state 54, and when the pins are located at the lower ends of the slots 80 the locking device 30 is in the unlocked state. In this way, gravity tends to bias the locking device 30 toward the locked state 54 thus preventing unintended release of the device. Because the bracket 50 slides vertically within the gap 48 and between the released and locked states 32, 54, the longitudinal length of the bracket 50 is shorter than the length of the gap 48 by a distance about equal to the longitudinal length of any one of the slots 80 of the sliding coupler 78.

The locking device 30 also has a releasable interlock 88 carried between the second wall 74 of the web 52 and the distal edge face 46 of the right shutter 24. The interlock has a plurality of vertically spaced mortises 90 in the second wall 74 of the bracket 50 and a plurality of vertically spaced tenons 92 projecting outward from the edge face 46. Preferably, the mortises 90 are shaped generally like inverted keyholes having an enlarged round section 94 communicating upward with a vertically extending notch section 96. The mortises 90 are preferably similar to the pins 82, having a shank 98 projecting rigidly from the edge face 46 of the right shutter 24 to a distal enlarged head 100. The head 100 has a diameter slightly smaller than the diameter of the round section 94 and larger than the width of the notch section 96.

Preferably the locking device 30 has two handles 102 for assisting in the initial pull of the shutters 22, 24 out of the closed position 24 from outside and inside of the building, and preferably to assist in the pull of the shutters 22, 24 into the closed position 24 from outside and inside the building. Each handle has a substantially linear rod 104 that slidably projects the mid portions 68, 70 of the inner and outer flanges 60, 92 and thus traversing the channel 76. The rod 104 has an end 106 and an opposite internal end 108 each pivotally supporting respective pull stops or rings 110, 112 respectively located externally and internally with regard to the building.

During closure operation of the assembly 20 with the user situated in the building, and when the shutters 22, 24 are slid along the respective directions 25, 27 toward the closed position 34, the pull rings 112 are grasped causing the rods 104 of the handles 102 to preferably slide transversely through the bracket 50 until the external pull ring 110 abuts the mid portion 70 of the outer flange 58. With the shutters 22, 24 continuing to slide closed, the now extended rod portion 114 can be used as a leverage to lift the bracket 50 upward toward the release state 32. When so doing, the pins 82 of the sliding coupler 78 are relocated from the upper ends of the respective slots 80 to the lower ends. This positions the round section 94 of the mortise 90 of the releasable interlock 88 substantially level with the respective tenons 92. Final closure of the shutters 22, 24 places the edge face 46 of the right shutter 46 between the right fins 64, 66 of the inner and outer flanges 56, 58 and places the enlarged heads 100 of the tenons 92 through the round section 94 and into the channel 76. When the shutter assembly 20 is in the closed position 34, the user with the assistance of gravity can push down upon the leveraging rod portion 114 causing the shanks 98 of the tenons 92 to position in the notch sections 96 of the mortises 90 thus placing the locking device 30 in the locked state 54.

During opening operation of the assembly 20 and with, for example, the user situated outside of the building, the external pull rings 110 of the handles 102 are grasped and pulled outward causing the rods 104 of the handles 102 to slide transversely through the bracket 50 until the internal pull ring 112 abuts the mid portion 68 of the inner flange 56. Before the shutters 22, 24 can begin to open, the locking device 30 must be slid upward from the locked state 54 and into the released state 32. To do this, the exposed rod portions are leveraged or pushed upward by the user then pushed along direction 25 to release the device 30. With the bracket 50 clear of the right shutter 24, the shutters can be freely moved toward the wide open position.

One skilled in the art would now know that modifications to the preferred invention may include the omission of the inner or outer flange 56, 58 and the web 52 of the bracket 50 of the locking device 30. For instance, a modified bracket could include only the inner flange with the sliding coupling carried between the left shutter and a left fin of the flange and the releasable interlock carried between a right fin of the flange and the right shutter. Various combinations of the bracket, the sliding coupling and the releasable interlock are now conceivable, however, rigidity and strength of the assembly 20 could be compromised and the desirable ability to operate the handles 102 from inside and outside of the building could be eliminated.

Moreover, one skilled in the art would now know that the shutters 22, 24 could also be a French door wall arrangement. Yet further, the sliding arrangement of the shutters may be modified to create a pivoting arrangement as indicated by pivoting axes 26, 28 (as best shown in FIG. 1). More specifically, the left shutter 22 may have a substantially vertical pivoting axis 26 located proximate to a left side of an opening in the structure such as a door or window, and the second or right shutter 24 may have a pivoting axis 28 orientated substantially parallel to axis 26 and located proximate to the right side of the opening. For pivoting shutters, however, the clearance between the inner and outer flanges would be greater, at least in part, than the thickness of the shutters. This could potentially degrade the locking strength of the shutters when in the closed position 34.

Although the preferred embodiment of the present invention has been disclosed, various changes and modifications may be made thereto by one skilled in the art without departing from the scope and spirit of the invention as set forth in the appended claims. It is also understood that the terms used herein are merely descriptive, rather than limiting, and that various changes may be made without departing from the scope and spirit of the invention.

What is claimed is:

1. A locking shutter assembly for protectively covering an opening of a building comprising:
a first shutter mounted to the building at a first side of the opening, the first shutter having an elongated first edge face;
a second shutter mounted to the building at an opposite second side of the opening, the second shutter assembly having a second edge face;
a closed position wherein the locking device and the first and second shutters cover the opening and the first and second edge face;
an open position wherein the locking device and the first and second shutters are clear of the opening;
an elongated gap defined by the first and second edge faces when the assembly is in the closed position; and
a locking device having an elongated member extending longitudinally along the gap, supported slidably by the first shutter when in the open and closed positions, and constructed and arranged to lock releasably to the second shutter when in the closed position.

2. The locking shutter assembly set forth in claim 1 wherein the elongated member slides between a locked state and a released state when the assembly is in the closed position.

3. The locking shutter assembly set forth in claim 2 further comprising:
an elongated web of the locking device located in the gap when the assembly is in the closed position; and
a releasable interlock of the locking device carried between the web and the second edge face.

4. The locking shutter assembly set forth in claim 3 further comprising:
at least one tenon of the releasable interlock projecting from one of the second edge face or the web and disposed in the gap; and
at least one mortise of the releasable interlock located in the other one of the web or the edge face for receipt of the tenon when the assembly is in the closed position; and
wherein sliding of the member from the released state to the lock state relocates each one of the at least one tenon in a respective one of the at least one mortise.

5. The locking shutter assembly set forth in claim 4 wherein each one of the at least one mortise has a keyhole shape and each one of the at least one tenon has an enlarged head located in the respective mortise when the assembly is in the closed position and the locking device is in the released state and in the locked state.

6. The locking shutter assembly set forth in claim 5 wherein the web defines at least in-part a channel and the enlarged head is located in the channel when the assembly is in the closed position.

7. The locking shutter assembly set forth in claim 6 further comprising a handle of the locking device having a rod projecting slidably through the web and through the channel.

8. The locking shutter assembly set forth in claim 1 wherein at least one of the first and second shutters slide between the open and closed positions.

9. A locking shutter assembly for protectively covering an opening of a building comprising:
a first shutter mounted to the building;
a second shutter mounted to the building;
a gap defined between the first and second shutters when in a closed position; and
a locking device having a bracket extending longitudinally along the gap and spanning laterally across the gap when the assembly is in the closed position, a sliding coupling carried between the first shutter and the bracket, and a releasable interlock carried between the second shutter and the bracket.

10. The locking shutter assembly set forth in claim 9 further comprising the sliding coupling having a pin projecting from one of the first shutter and the bracket, and a slot located in the other of the first shutter and the bracket and through which the pin projects.

11. The locking shutter assembly set forth in claim 10 wherein the pin projects through the slot regardless of whether the assembly is in the closed position or in an open position.

12. The locking shutter assembly set forth in claim 9 further comprising the releasable interlock having a tenon projecting from one of the second shutter and the bracket, and a mortise located in the other of the second shutter and the bracket for receipt of the tenon when the assembly is in the closed position.

13. The locking shutter assembly set forth in claim 12 wherein the mortise is an inverted keyshape.

14. The locking shutter assembly set forth in claim 11 further comprising:
a distal enlarged head of the pin having a diameter that is greater than a width of the slot; and
a shank of the pin projecting rigidly between the first shutter and the distal enlarged head and having a diameter that is less than the width of the slot.

15. The locking shutter assembly set forth in claim 9 further comprising the releasable interlock having a tenon projecting from the second shutter and a mortise located in the bracket for receipt of the tenon when the assembly is in the closed position and clear of the mortise when the assembly is not in the closed position.

16. The locking shutter assembly set forth in claim 15 wherein the mortise is an inverted keyshape having a lower round section and an upper elongated notch section extending longitudinally in a parallel direction to the slot.

17. The locking shutter assembly set forth in claim 11 further comprising:
the first shutter having a first surface and an opposite second surface;
the pin being a first pin projecting rigidly outward from the first surface; and
a second pin of the sliding coupling projecting outward from the second surface and in an opposite direction to the first pin and through a second slot in the bracket.

18. The locking shutter assembly set forth in claim 17 further comprising:
a web of the bracket disposed in the gap when the assembly is in the closed position;
a first fin of the bracket projecting outward from the web and over the first surface;
a second fin of the bracket projecting outward from the web and over the second surface; and
wherein the slot is in the first fin and the second slot is in the second fin.

19. The locking shutter assembly set forth in claim 10 wherein the bracket is shorter than the gap by a distance equal to or greater than a length of the slot.

20. The locking assembly set forth in claim 9 wherein the first and second shutters are mounted to the building along respective pivoting axes spaced from and disposed parallel to one-another.
